(19) United States
(12) Patent Application Publication
(10) Pub. No.: US 2012/0299299 A1
(43) Pub. Date: Nov. 29, 2012

(54) SELF GENERATING POWER SOURCE

(75) Inventors: Fu-Ho Chan, Kaohsiung (TW); Pin-Hung Chen, Kaohsiung (TW); Wen-Long Lu, Kaohsiung (TW); Kuo-Tung Cheng, Kaohsiung (TW)

(73) Assignee: TAIMAG CORPORATION, Kaohsiung (TW)

(21) Appl. No.: 13/117,945

(22) Filed: May 27, 2011

(51) Int. Cl. F03G 7/08

(52) U.S. Cl. 290/50

(57) ABSTRACT

A self generating power source includes a housing unit including a housing body, and an energy conversion unit, a rectifying unit and an energy storage unit all disposed inside the housing body. The energy conversion unit includes two first induction members and a second induction member. The first induction members are movable relative to the second induction member for generating an alternating current in the second induction member by virtue of electromagnetic induction. Each first induction member has two magnetic poles opposite to each other in polarity. The first induction members are disposed such that two of the magnetic poles of the first induction members having the same polarity are disposed to confront each other. The rectifying unit is coupled electrically to the second induction member for converting the alternating current into a direct current. The energy storage unit is coupled electrically to the rectifying unit for storing the direct current.

### BACKGROUND OF THE INVENTION

1. Field of the Invention

The invention relates to a power source, more particularly to a self generating power source.

2. Description of the Related Art

With reference to FIG. 1, Taiwanese Utility Model Publication No. M319580 entitled “self generating battery” discloses a conventional self generating battery 1 that includes a tubular housing 11, an induction member 12, a coil unit 13 and an energy storage unit 14.

The induction member 12 has two magnetic poles that are opposite to each other in polarity, and is movably or slidably disposed in the tubular housing 11. The coil unit 13 is disposed on the outer peripheral surface of the tubular housing 11. The energy storage unit 14 is connected electrically to the coil unit 13. By shaking the self generating battery 1, the induction member 12 slides relative to the coil unit 13 so as to generate electrical energy.

However, while many portable electronic devices, such as flash lights, portable stereos, etc., use multiple series-connected batteries as their power sources, when the conventional self generating batteries 1 are used in series, adjacent ones of the induction members 12 of an adjacent pair of the conventional self generating batteries 1 are magnetically attracted to each other since adjacent magnetic poles of the adjacent induction members 12 are of opposite polarity, such that the range of movement of the induction member 12 relative to the coil unit 13 of one conventional self generating battery 1 is limited by the other conventional self generating battery 1, thereby resulting in poor power generating performance. Consequently, in order to obtain better power generating performance, it is necessary to take the conventional self generating batteries 1 out of the portable electronic devices, and shake the conventional self generating batteries 1 individually, which is inconvenient.

### SUMMARY OF THE INVENTION

Therefore, the object of the present invention is to provide a self generating power source that can eliminate the aforesaid drawback of the prior art.

According to one aspect of the present invention, there is provided a self generating power source that includes a housing unit, an energy conversion unit, a rectifying unit, and an energy storage unit. The housing unit includes a housing body. The energy conversion unit is disposed inside the housing body and includes two first induction members and a second induction member. The first induction members are movable relative to the second induction member so as to generate an alternating current in the second induction member by virtue of electromagnetic induction. Each of the first induction members has two magnetic poles that are opposite to each other in polarity. The first induction members are disposed such that two of the magnetic poles of the first induction members having the same polarity are disposed to confront each other. The rectifying unit is disposed inside the housing body, and is coupled electrically to the second induction member for converting the alternating current into a direct current. The energy storage unit is disposed inside the housing body, and is coupled electrically to the rectifying unit for storing the direct current.

According to another aspect of the present invention, there is provided a self generating power source that includes a housing unit, an energy conversion unit, a rectifying unit and an energy storage unit. The housing unit includes a housing body. The energy conversion unit is disposed inside the housing body and includes a first induction member and a second induction member. The first induction member is movable relative to the second induction member so as to generate an alternating current in the second induction member by virtue of electromagnetic induction. The energy conversion unit further includes two repulsing members disposed inside the housing body and having the first induction member interposed therebetween for providing repulsive forces to the first induction member. The rectifying unit is disposed inside the housing body, and is coupled electrically to the second induction member for converting the alternating current into a direct current. The energy storage unit is disposed inside the housing body, and is coupled electrically to the rectifying unit for storing the direct current.

According to still another aspect of the present invention, there is provided a self generating power source that includes a housing unit, an energy conversion unit, a rectifying unit, and an energy storage unit. The housing unit includes a housing body. The energy conversion unit is disposed inside the housing body and includes a magnet set and a coil member. The coil member is movable relative to the magnet set so as to generate an alternating current therein by virtue of electromagnetic induction. The rectifying unit is disposed inside the housing body, and is coupled electrically to the coil member for converting the alternating current into a direct current. The energy storage unit is disposed inside the housing body, and is coupled electrically to the rectifying unit for storing the direct current.

The advantages and effects of the present invention lie in that: magnetic attraction between adjacent ones of the first induction members of an adjacent series connected pair of the self generating power source is avoided, such that the range of relative movement between the first and second induction members or between the magnet set and the coil member of a self generating power source is not limited by another, adjacent self generating power source. Moreover, when the self generating power source runs out of electricity, it does not need to be removed for individual manipulation, but can be shook together with other self generating power sources when multiple ones of the self generating power sources are connected in series inside an electronic device, thereby enhancing convenience during use.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating a conventional self generating battery disclosed in Taiwanese Utility Model Publication No. M319580;

FIG. 2 is a schematic diagram illustrating the first preferred embodiment of a self generating power source according to the present invention;

FIG. 3 is a schematic diagram illustrating the second preferred embodiment of a self generating power source according to the present invention;

FIG. 4 is a schematic diagram illustrating the third preferred embodiment of a self generating power source according to the present invention;

FIG. 5 is a schematic diagram illustrating the fourth preferred embodiment of a self generating power source according to the present invention; and

FIG. 6 is a schematic diagram illustrating the fifth preferred embodiment of a self generating power source according to the present invention.

### DETAILED DESCRIPTION OF THE PREFERRED EMBODIMENTS

Before the present invention is described in greater detail, it should be noted that like elements are denoted by the same reference numerals throughout the disclosure.

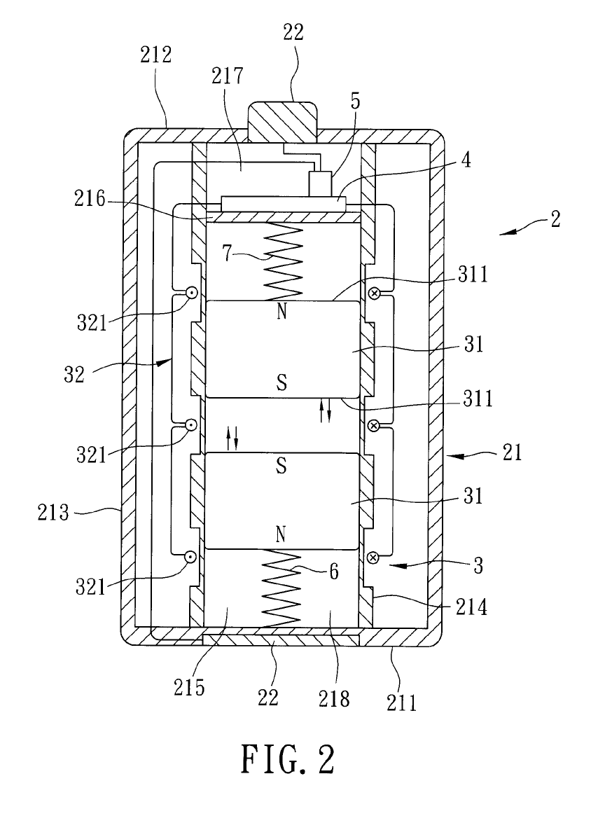

With reference to FIG. 2, the first preferred embodiment of a self generating power source according to the present invention includes a housing unit 2, an energy conversion unit 3, a rectifying unit 4, and an energy storage unit 5.

The housing unit 2 includes a housing body 21. The energy conversion unit 3 is disposed inside the housing body 21, and includes two first induction members 31 and a second induction member 32. The first induction members 31 are movable relative to the second induction member 32 so as to generate an alternating current in the second induction member 32 by virtue of electromagnetic induction. Each of the first induction members 31 has two magnetic poles 311 that are opposite to each other in polarity (N, S). The first induction members 31 are disposed such that two of the magnetic poles 311 of the first induction members 31 having the same polarity are disposed to confront each other (i.e., with the (S) polarities confronting each other or with the (N) polarities confronting each other). The rectifying unit 4 is disposed inside the housing body 21, and is coupled electrically to the second induction member 32 for converting the alternating current into a direct current. The energy storage unit 5 is disposed inside the housing body 21, and is coupled electrically to the rectifying unit 4 for storing the direct current.

In this embodiment, the housing unit 2 is in the form of a battery housing, and further includes two electrical contacts 22. The electrical contacts 22 are spacedly disposed on the housing body 21, and are coupled electrically to the energy storage unit 5 to serve as positive and negative terminals, respectively. In this case, the self generating power source acts as an “environmentally friendly, self generating, rechargeable” battery.

The housing body 21 includes a bottom wall 211, a top wall 212 disposed opposite to the bottom wall 211, an outer surrounding wall 213 extending from the bottom wall 211 to the top wall 212, and an inner surrounding wall 214 extending from the bottom wall 211 to the top wall 212, spaced apart from and surrounded by the outer surrounding wall 213, and cooperating with the bottom and top walls 211, 212 to define a receiving space 215. The housing body 21 further includes a partition plate 216 disposed in the receiving space 215 and dividing the receiving space 215 into a first compartment 217 and a second compartment 218. The rectifying unit 4 and the energy storage unit 5 are disposed in the first compartment 217. The first induction members 31 are movably disposed in the second compartment 218. The second induction member 32 is disposed in a space defined between the inner and outer surrounding walls 214, 213.

In this embodiment, each of the first induction members 31 is a magnet, and the second induction member 32 is a coil member. In particular, the second induction member 32 includes three sets of windings 321. However, the second induction member 32 is not limited in the number of windings 321 thereof, and may include any number of windings 321 other than that disclosed herein in other embodiments of the present invention.

Moreover, the electrical contacts 22 are respectively disposed on the top and bottom walls 212, 211. In addition, the self generating power source further includes a first resilient member 6 connected between the bottom wall 211 and one of the first induction members 31, and a second resilient member 7 connected between the partition plate 216 and the other of the first induction members 31. It should be noted herein that although the first and second resilient members 6, 7 are illustrated as spring members in this embodiment, the first and second resilient members 6, 7 may also be two resilient pieces or any other resilient objects in other embodiments of the present invention.

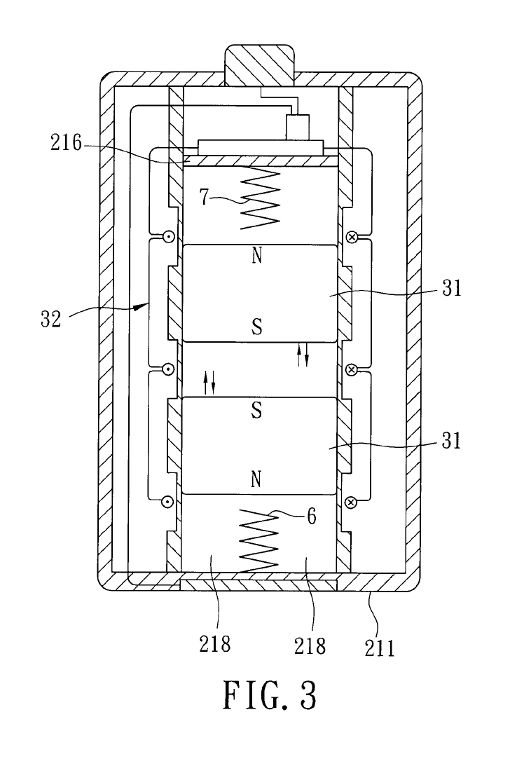

With reference to FIG. 3, the second preferred embodiment of a self generating power source according to the present invention differs from the first preferred embodiment in that the first resilient member 6 is disposed in the second compartment 218 and is connected to the bottom wall 211, and the second resilient member 7 is disposed in the second compartment 218 and is connected to the partition plate 216. In both the first and second preferred embodiments, the first and second resilient members 6, 7 buffer movements of the first induction members 31 in the second compartment 218.

For the first and second preferred embodiments disclosed above, when multiple ones of the self generating power sources are disposed in series connection in an electronic device, a user may shake the whole electronic device together with the multiple self generating power sources disposed therein in order for the multiple self generating power sources to generate electrical energy in the form of electrical current by virtue of electromagnetic induction between the first and second induction members 31, 32 as a result of relative movement therebetween.

With the above-disclosed designs, the self generating power source of the present invention has the following advantages:

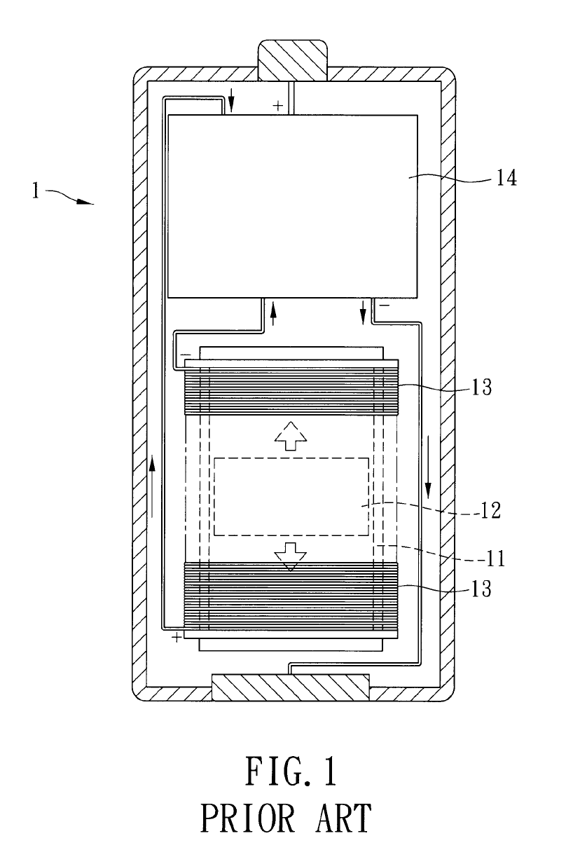

1. Power Generating Performance is Enhanced.
With the first induction members 31 disposed such that two of the magnetic poles 311 of the first induction members 31 having the same polarity confront each other, as opposed to having only one induct ion member 12 in the tubular housing 11 (as shown in FIG. 1) in the prior art, the situation is prevented where magnetic attraction occurs between adjacent first induction members 31 of an adjacent pair of the self generating power sources when multiple ones of the self generating power sources are disposed in series connection via the electrical contacts 22. As a result, the movement between the first and second induction members 31, 32 of one self generating power source is not limited by the magnetic attraction when disposed adjacent to another self generating power source.

2. Convenience During Use is Enhanced.
In view of the fact that no magnetic attraction would occur between adjacent ones of the self generating power sources, there is no need to remove the self generating power sources from the electronic device and manipulate (through shaking) the self generating power sources individually in order to generate electrical power at a high efficiency.

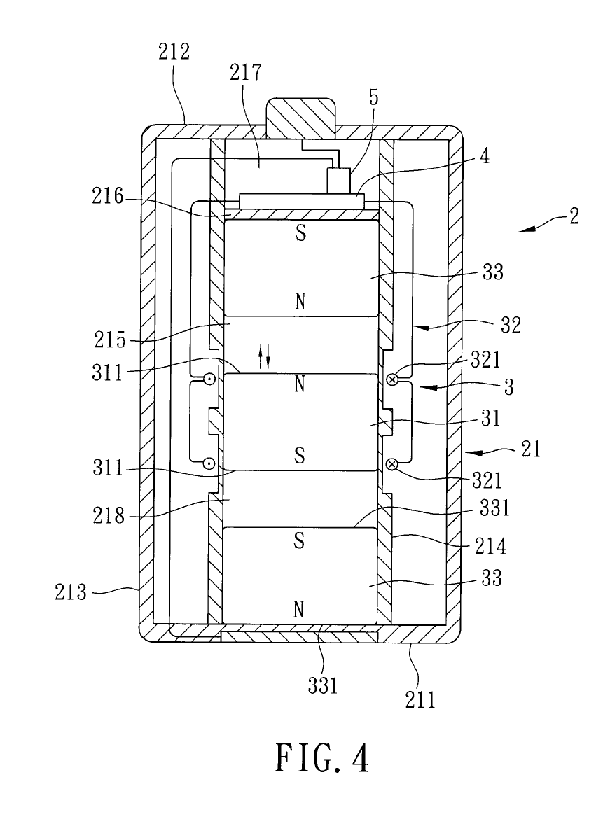

With reference to FIG. 4, the third preferred embodiment of a self generating power source according to the present invention differs from the first preferred embodiment in that the energy conversion unit 3 includes a first induction member 31, a second induction member 32, and two repulsing members 33. The first induction member 31 is movable relative to the second induction member 32 so as to generate an alternating current in the second induction member 32 by virtue of electromagnetic induction. The repulsing members 33 are disposed inside the housing body 21 and have the first induction member 31 interposed therebetween for providing repulsive forces to the first induction member 31.

In this embodiment, each of the first induction member 31 and the repulsing members 33 is a magnet, and has two magnetic poles 311, 331 that are opposite to each other in polarity (N, S). Each of the magnetic poles 311 of the first induction member 31 is disposed to confront one of the magnetic poles 331 of a respective one of the repulsing members 33 having the same polarity (i.e., with the S polarities confronting each other and/or with the N polarities confronting each other). Moreover, the second induction member 32 is a coil member with two sets of windings 321 in this embodiment, but is not limited thereto.

Similar to the first preferred embodiment, the housing body 21 of the third preferred embodiment includes a bottom wall 211, a top wall 212 disposed opposite to the bottom wall 211, an outer surrounding wall 213 extending from the bottom wall 211 to the top wall 212, and an inner surrounding wall 214 extending from the bottom wall 211 to the top wall 212, spaced apart from and surrounded by the outer surrounding wall 213, and cooperating with the top and bottom walls 212, 211 to define a receiving space 215. The housing body 21 further includes a partition plate 216 disposed in the receiving space 215 and dividing the receiving space 215 into a first compartment 217 and a second compartment 218. The rectifying unit 4 and the energy storage unit 5 are disposed in the first compartment 217, the first induction member 31 is movably disposed in the second compartment 218, the repulsing members 33 are non-movably disposed in the second compartment 218, and the second induction member 312 is disposed in a space defined between the inner and outer surrounding walls 214, 213.

With this structural design, the same advantages and effects as with the first and second preferred embodiments may be achieved by the third preferred embodiment.

It should be noted herein that although the repulsing members 33 are illustrated as magnets in this embodiment, they may be resilient members (such as the first and second resilient members 6, 7 shown in FIGS. 2 and 3) in other embodiments of the present invention.

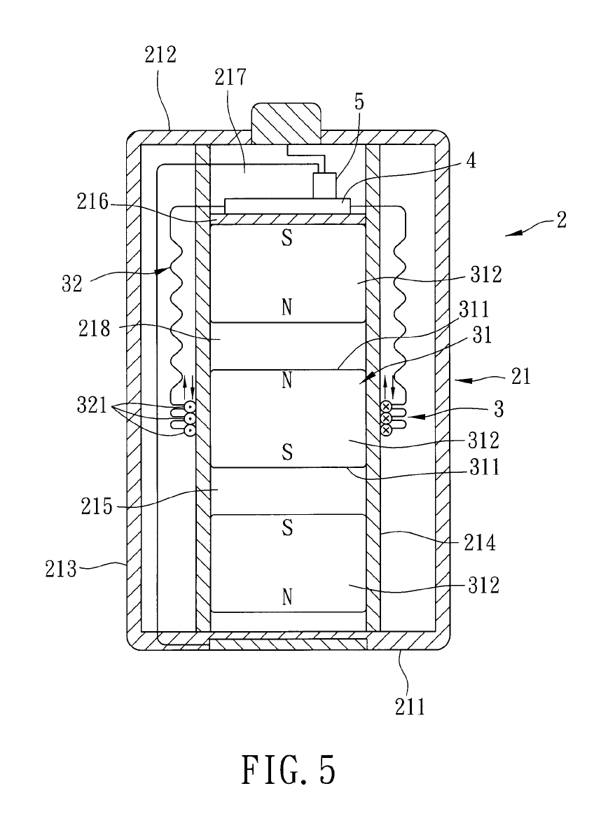

With reference to FIG. 5, the fourth preferred embodiment of a self generating power source according to the present invention differs from the previous embodiments in that the energy conversion unit 3 includes a magnet set 31 and a coil member 32. The coil member 32 is movable relative to the magnet set 31 so as to generate an alternating current therein by virtue of electromagnetic induction. The rectifying unit 4 is coupled electrically to the coil member 32 for converting the alternating current into a direct current. The energy storage unit 5 is coupled electrically to the rectifying unit 4 for storing the direct current.

The magnet set 31 includes a plurality of magnets 312 each having two magnetic poles 311 that are opposite to each other in polarity (N, S). The magnets 312 are spacedly disposed in the housing body 21 such that two of the magnetic poles 311 of an adjacent pair of the magnets 312 having the same polarity are disposed to confront each other.

Similar to the aforementioned embodiments, the housing body 21 includes a bottom wall 211, a top wall 212 disposed opposite to the bottom wall 211, an outer surrounding wall 213 extending from the bottom wall 211 to the top wall 212, and an inner surrounding wall 214 extending from the bottom wall 211 to the top wall 212, spaced apart from and surrounded by the outer surrounding wall 213, and cooperating with the top and bottom walls 212, 211 to define a receiving space 215. The housing body 21 further includes a partition plate 216 disposed in the receiving space 215 and dividing the receiving space 215 into a first compartment 217 and a second compartment 218. The rectifying unit 4 and the energy storage unit 5 are disposed in the first compartment 217. The magnet set 31 is non-movably disposed in the second compartment 218, and the coil member 32 is disposed in a space defined between the inner and outer surrounding walls 214, 213.

With this structural design, the same advantages and effects as with the first and second preferred embodiments may be achieved by the fourth preferred embodiment.

It should be noted herein that although the magnet set 31 includes three magnets 312 in this embodiment, the number of magnets 312 included in the magnet set 31 is not limited in the present invention. In addition, although the coil member 32 is shown to include three sets of windings 321 in this embodiment, the number of windings 321 is not limited in the present invention.

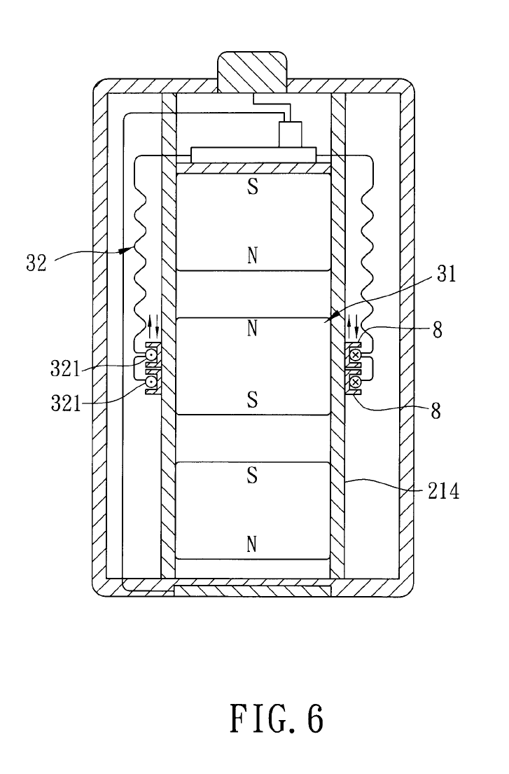

With reference to FIG. 6, the fifth preferred embodiment of a self generating power source according to the present invention differs from the fourth preferred embodiment in that the fifth preferred embodiment further includes a carriage 8 that is sleeved slidably on the inner surrounding wall 214 and that is connected to the coil member 32 such that the coil member 32 is movable relative to the magnet set 31.

It should be noted herein that although the coil member 32 is shown to include two sets of windings 321 in this embodiment, and accordingly there are provided two of the carriages 8 for respectively connecting to the windings 321, the number of windings 321 and the number of carriages 8 are not limited in the present invention.

In summary, by providing two first induction members 31 that are disposed such that two of the magnetic poles 311 of the first induction members 31 having the same polarity are disposed to confront each other to avoid magnetic attraction in adjacent series connected ones of the self generating power sources, by providing repulsing members 33 to maintain the first induction member(s) 31 within a proper movement boundary, or by fixing the magnet set 31 inside the housing body 21 and making the coil member 32 the movable component for electromagnetic induction, the range of relative movement between the first and second induction members 31, 32 and between the magnet set 31 and the coil member 32 of one self generating power source is not further limited by another, adjacent self generating power source when multiple ones of the self generating power sources of the present invention are disposed in series connection, thereby enhancing power generating performance. Furthermore, when multiple ones of the self generating power sources of the present invention are disposed in series connection in an electronic device, and run out of electricity, the electronic device along with the multiple self generating power sources can be shook altogether for power generation without affecting the power generation efficiency, thereby enhancing convenience during use.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A self generating power source, comprising:
a housing unit including a housing body;
an energy conversion unit disposed inside said housing body and including two first induction members and a second induction member, said first induction members being movable relative to said second induction member so as to generate an alternating current in said second induction member by virtue of electromagnetic induction, each of said first induction members having two magnetic poles that are opposite to each other in polarity, said first induction members being disposed such that two of said magnetic poles of said first induction members having the same polarity are disposed to confront each other;
a rectifying unit disposed inside said housing body, and coupled electrically to said second induction member for converting the alternating current into a direct current; and
an energy storage unit disposed inside said housing body, and coupled electrically to said rectifying unit for storing the direct current.

2. The self generating power source as claimed in claim 1, wherein said housing unit is in the form of a battery housing and further includes two electrical contacts spacedly disposed on said housing body, and coupled electrically to said energy storage unit to serve as positive and negative terminals, respectively.

3. The self generating power source as claimed in claim 1, wherein said housing body includes a bottom wall, a top wall disposed opposite to said bottom wall, an outer surrounding wall extending from said bottom wall to said top wall, and an inner surrounding wall extending from said bottom wall to said top wall, spaced apart from and surrounded by said outer surrounding wall, and cooperating with said top and bottom walls to define a receiving space, said housing body further including a partition plate disposed in said receiving space and dividing said receiving space into a first compartment and a second compartment, said rectifying unit and said energy storage unit being disposed in said first compartment, said first induction members being movably disposed in said second compartment, said second induction member being disposed in a space defined between said inner and outer surrounding walls.

4. The self generating power source as claimed in claim 3, further comprising a first resilient member connected between said bottom wall and one of said first induction members, and a second resilient member connected between said partition plate and the other of said first induction members.

5. The self generating power source as claimed in claim 4, wherein said first and second resilient members are spring members.

6. The self generating power source as claimed in claim 3, further comprising a first resilient member disposed in said second compartment and connected to said bottom wall, and a second resilient member disposed in said second compartment and connected to said partition plate, said first and second elastic members buffering movements of said first induction members in said second compartment.

7. The self generating power source as claimed in claim 6, wherein said first and second resilient members are spring members.

8. The self generating power source as claimed in claim 1, wherein each of said first induction members is a magnet, and said second induction member is a coil member.

9. A self generating power source, comprising:
a housing unit including a housing body;
an energy conversion unit disposed inside said housing body and including a first induction member and a second induction member, said first induction member being movable relative to said second induction member so as to generate an alternating current in said second induction member by virtue of electromagnetic induction, said energy conversion unit further including two repulsing members disposed inside said housing body and having said first induction member interposed therebetween for providing repulsive forces to said first induction member;
a rectifying unit disposed inside said housing body, and coupled electrically to said second induction member for converting the alternating current into a direct current; and
an energy storage unit disposed inside said housing body, and coupled electrically to said rectifying unit for storing the direct current.

10. The self generating power source as claimed in claim 9, wherein said housing unit is in the form of a battery housing and further includes two electrical contacts spacedly disposed on said housing body, and coupled electrically to said energy storage unit to serve as positive and negative terminals, respectively.

11. The self generating power source as claimed in claim 9, wherein each of said first induction member and said repulsing members is a magnet and has two magnetic poles that are opposite to each other in polarity, each of said magnetic poles of said first induction member being disposed to confront one of said magnetic poles of a respective one of said repulsing members having the same polarity, said second induction member being a coil member.

12. The self generating power source as claimed in claim 9, wherein said housing body includes a bottom wall, a top wall disposed opposite to said bottom wall, an outer surrounding wall extending from said bottom wall to said top wall, and an inner surrounding wall extending from said bottom wall to said top wall, spaced apart from and surrounded by said outer surrounding wall, and cooperating with said top and bottom walls to define a receiving space, said housing body further including a partition plate disposed in said receiving space and dividing said receiving space into a first compartment and a second compartment, said rectifying unit and said energy storage unit being disposed in said first compartment, said first induction member being movably disposed in said second compartment, said repulsing members being non-movably disposed in said second compartment, said second induction member being disposed in a space defined between said inner and outer surrounding walls.

13. The self generating power source as claimed in claim 9, wherein each of said repulsing members is a resilient member.

14. A self generating power source, comprising:
a housing unit including a housing body;
an energy conversion unit disposed inside said housing body and including a magnet set and a coil member, said coil member being movable relative to said magnet set so as to generate an alternating current therein by virtue of electromagnetic induction;
a rectifying unit disposed inside said housing body, and coupled electrically to said coil member for converting the alternating current into a direct current; and
an energy storage unit disposed inside said housing body, and coupled electrically to said rectifying unit for storing the direct current.

15. The self generating power source as claimed in claim 14, wherein said housing unit is in the form of a battery housing and further includes two electrical contacts spacedly disposed on said housing body, and coupled electrically to said energy storage unit to serve as positive and negative terminals, respectively.

16. The self generating power source as claimed in claim 14, wherein said magnet set includes a plurality of magnets each having two magnetic poles that are opposite to each other in polarity, said magnets being spacedly disposed in said housing body such that two of said magnetic poles of an adjacent pair of said magnets having the same polarity are disposed to confront each other.

17. The self generating power source as claimed in claim 14, wherein said housing body includes a bottom wall, a top wall disposed opposite to said bottom wall, an outer surrounding wall extending from said bottom wall to said top wall, and an inner surrounding wall extending from said bottom wall to said top wall, spaced apart from and surrounded by said outer surrounding wall, and cooperating with said top and bottom walls to define a receiving space, said housing body further including a partition plate disposed in said receiving space and dividing said receiving space into a first compartment and a second compartment, said rectifying unit and said energy storage unit being disposed in said first compartment, said magnet set being non-movably disposed in said second compartment, said coil member being disposed in a space defined between said inner and outer surrounding walls.

18. The self generating power source as claimed in claim 17, further comprising a carriage sleeved slidably on said inner surrounding wall and connected to said coil member such that said coil member is movable relative to said magnet set.
